(19) United States
(12) Patent Application Publication
(10) Pub. No.: US 2026/0362044 A1
(43) Pub. Date: Nov. 12, 2026

(54) OPEN EAR TYPE SOUND APPARATUS, SOUND SYSTEM

(71) Applicant: NTT, Inc., Tokyo (JP)

(72) Inventors: Hironobu CHIBA, Tokyo (JP); Tatsuya KAKO, Tokyo (JP); Hiroaki ITO, Tokyo (JP); Kenichi NOGUCHI, Tokyo (JP)

(73) Assignee: NTT, Inc., Tokyo (JP)

(21) Appl. No.: 19/490,809

(22) PCT Filed: May 16, 2024
(86) PCT No.: PCT/JP2024/018059

§ 371 Date: Dec. 5, 2025

(30) Foreign Application Priority Data
Jun. 7, 2023 (WO) PCT/JP2023/021192

(51) Int. Cl. H04R 1/10; H04R 3/00

(52) U.S. Cl. CPC H04R 1/1041; H04R 1/1016; H04R 1/1083; H04R 3/00; H04R 1/105; H04R 2460/01

(57) ABSTRACT

A first open-ear type sound apparatus of the present invention includes a housing, a speaker, a protruding portion, a microphone, and a signal processing unit. A second open-ear type sound apparatus of the present invention includes a housing, a protruding portion, and a microphone. The housing is an open-ear type. The speaker is positioned in the housing. The protruding portion is held by the housing or formed as a part of the housing so as to be positioned in the hollow space of the concha cavity or external ear canal. The microphone acquires sound at the position where the protruding portion is positioned. The signal processing unit generates a signal to be output from the speaker based on the sound information collected by the microphone.

### TECHNICAL FIELD

The present invention relates to an open-ear type sound apparatus, which is a sound apparatus having an open-ear type housing, and a sound system using the open-ear type sound apparatus.

### BACKGROUND ART

Headphones such as those shown in NPL 1 are known as wearable sound apparatus (earphones, headphones, and the like) that perform signal processing such as noise cancellation. Such sound apparatus are often closed type, and are known as closed-type headphones and canal-type earphones. In the case of closed-type sound apparatus, the ear holes are not open to the external environment.

### CITATION LIST

### Non Patent Literature

[NPL 1] SONY, Headphone “Wireless Noise-Cancelling Stereo Headset WH-1000XM4,” [Accessed May 23, 2023], Internet <https://www.sony.jp/headphone/products/WH-1000XM4/feature_1.html>.

### SUMMARY OF INVENTION

### Technical Problem

However, the conventional technology has the problem that it is isolated from the external environment and has parts that come into contact with the ear, which causes pressure and pain in the ear, and poses risks related to hygiene and the risk of diseases such as otitis externa. Even if the earphones are open type (open-ear type), if any parts come into contact with the concha cavity or external ear canal, there is a possibility that they will cause pressure and pain, which poses risks related to hygiene and increases the risk of diseases such as otitis externa.

The present invention has been made in consideration of such problems, and aims to provide a wearable sound apparatus that is less likely to cause a feeling of pressure or pain and reduces risks related to hygiene and other factors.

### Solution to Problem

A first open-ear type sound apparatus of the present invention includes a housing, a speaker, a protruding portion, a microphone, and a signal processing unit. A second open-ear type sound apparatus of the present invention includes a housing, a protruding portion, and a microphone. The housing is an open-ear type. The speaker is positioned in the housing. The protruding portion is held by the housing or formed as a part of the housing so as to be positioned in the hollow space of the concha cavity or external ear canal. The microphone acquires sound at the position where the protruding portion is positioned. The signal processing unit generates a signal to be output from the speaker based on the sound information collected by the microphone.

### Advantageous Effects of Invention

According to the open-ear type sound apparatus of the present invention, since the housing is an open-ear type and there are no parts that come into contact with the concha cavity and the external ear canal, it is less likely to cause a feeling of pressure or pain and risks related to hygiene and other factors can be reduced.

### BRIEF DESCRIPTION OF DRAWINGS

FIG. 1 is a diagram showing a first example of an open-ear type sound apparatus of the first embodiment.

FIG. 2 is a diagram showing an example of the functional configuration of a sound system using an open-ear type sound apparatus.

FIG. 3 is a diagram showing a second example of an open-ear type sound apparatus of the first embodiment.

FIG. 4 is a diagram showing a third example of an open-ear type sound apparatus of the first embodiment.

FIG. 5 is a diagram showing a fourth example of an open-ear type sound apparatus of the first embodiment.

FIG. 6 is a diagram showing a fifth example of an open-ear type sound apparatus of the first embodiment.

FIG. 7 is a diagram showing a sixth example of an open-ear type sound apparatus of the first embodiment.

FIG. 8 is a diagram showing an image of a structure in which a sound hole is provided at the tip of a protruding portion and a microphone is positioned inside the protruding portion.

FIG. 9 is a diagram showing an image of a structure in which a sound hole is provided midway through the protruding portion and a microphone is positioned inside the protruding portion.

FIG. 10 is a diagram showing an image of a structure in which a sound hole is provided at the tip of the protruding portion and a microphone is positioned inside the housing.

FIG. 11 is a front view of a microphone 140 positioned on the right ear side (φ=0) in the hollow space of the concha cavity of the left ear.

FIG. 12 is a left side view of the microphone 140 positioned on the right ear side (φ=0) in the hollow space of the concha cavity of the left ear.

FIG. 13 is a left side view of the microphone 140 positioned 30 degrees forward (φ=30) from the right ear side in the hollow space of the concha cavity of the left ear.

FIG. 14 is a view from the left side of the microphone 140 positioned 30 degrees behind (φ=−30) from the right ear side in the hollow space of the concha cavity of the left ear.

FIG. 15 is a front view of the microphone 140 positioned near the external ear hole.

FIG. 16 is a front view of the microphone 140 positioned on the side surface of the housing 110 (side surface of the housing).

FIG. 17 is a front view of the microphone 140 positioned on the rear surface of the housing 110 (rear surface of the housing).

FIG. 18 is a diagram showing the noise suppression performance of noise collected by the microphone 140 when feedback-type active noise cancelling (ANC) is applied using sound information collected by the microphone 140.

FIG. 19 is a diagram showing the noise suppression performance of noise collected by a dummy head in-ear microphone when feedback-type active noise cancelling (ANC) is applied using sound information collected by the microphone 140.

FIG. 20 is a diagram showing sound reproduced by a secondary sound source and collected by the microphone 140.

FIG. 21 is a diagram showing sound reproduced by a secondary sound source and collected by a dummy head in-ear microphone.

FIG. 22 is a diagram showing the correlation coefficient between sound collected by the microphone 140 and sound collected by a dummy head in-ear microphone.

FIG. 23 is a diagram showing sound reproduced by a primary sound source and collected by the microphone 140.

FIG. 24 is a diagram showing sound reproduced by a primary sound source and collected by a dummy head in-ear microphone.

FIG. 25 is a diagram showing the correlation coefficient between sound collected by the microphone 140 and sound collected by a dummy head in-ear microphone.

### DESCRIPTION OF EMBODIMENTS

Hereinafter, an embodiment of the present invention will be described in detail. Components having the same functions will be denoted by the same reference numerals, and the repeated description thereof will be omitted.

### First Embodiment

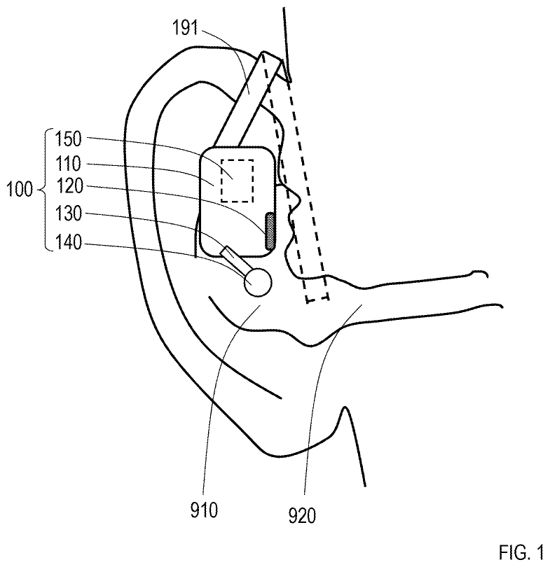

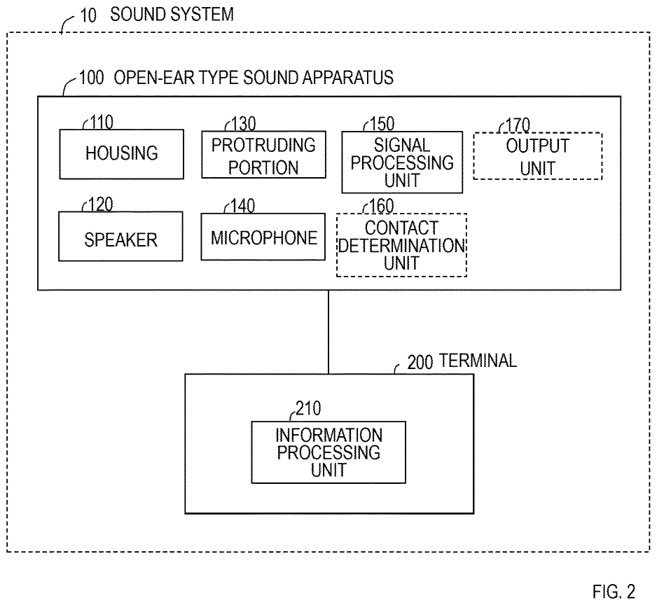

FIG. 1 shows a first example of an open-ear type sound apparatus of the first embodiment. The open-ear type sound apparatus shown in FIG. 1 is an earphone type. FIG. 2 shows an example of the functional configuration of a sound system using an open-ear type sound apparatus. The open-ear type sound apparatus 100 includes a housing 110, a speaker 120, a protruding portion 130, a microphone 140, and a signal processing unit 150. The open-ear type sound apparatus 100 may also include a contact determination unit 160 and an output unit 170. The sound system 10 includes the open-ear type sound apparatus 100 and a terminal 200 connected to the open-ear type sound apparatus 100. The terminal 200 includes an information processing unit 210 that performs predetermined information processing using the sound information collected by the microphone 140. However, the terminal 200 may be incorporated inside the open-ear type sound apparatus 100, or may exist on a server such as a cloud.

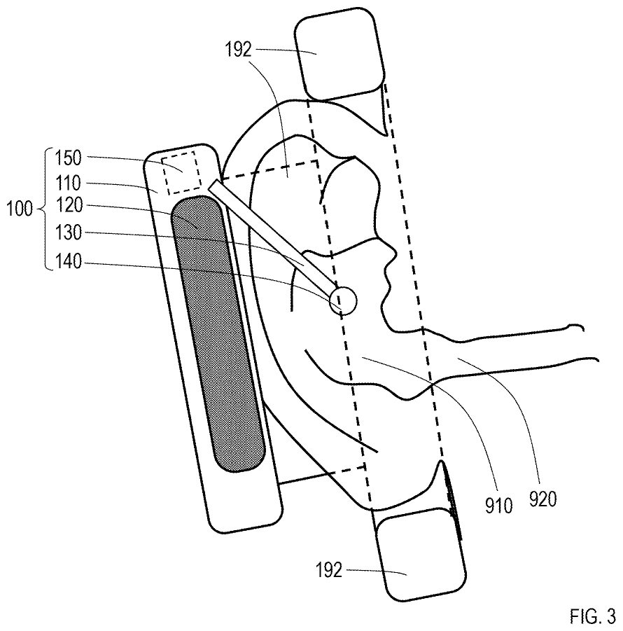

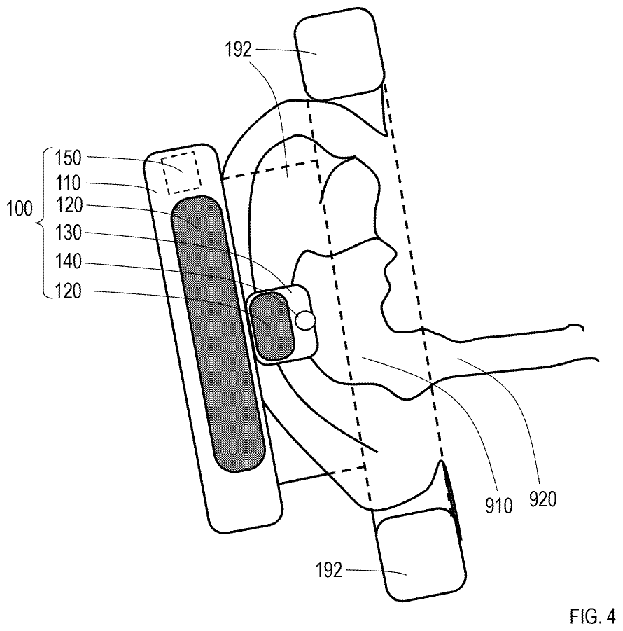

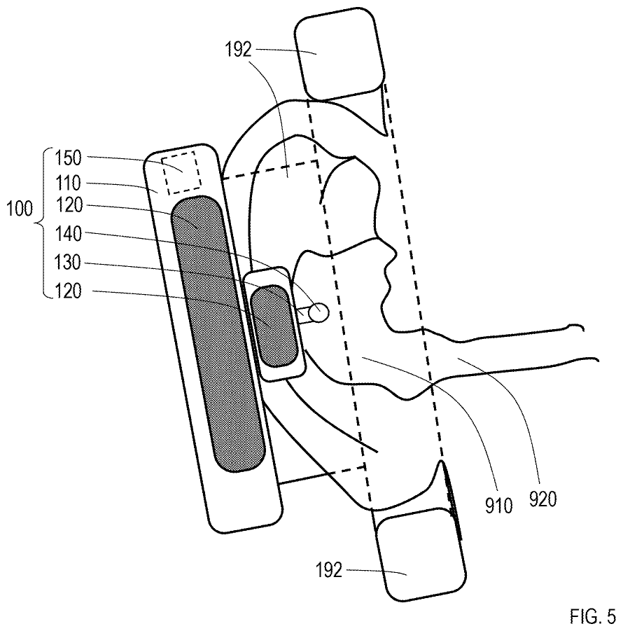

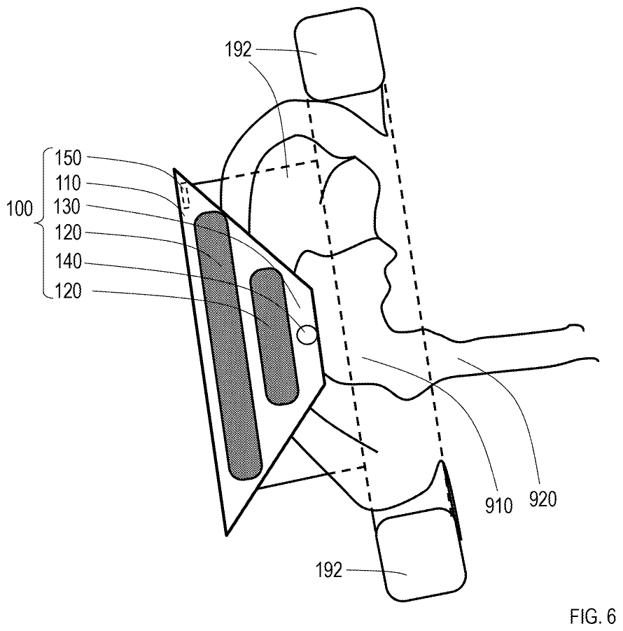

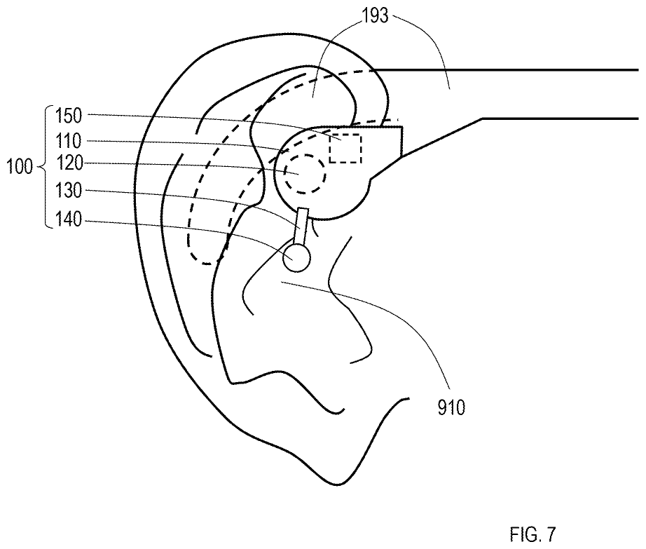

FIG. 3 shows a second example of the open-ear type sound apparatus of the first embodiment, FIG. 4 shows a third example of the open-ear type sound apparatus of the first embodiment, FIG. 5 shows a fourth example of the open-ear type sound apparatus of the first embodiment, and FIG. 6 shows a fifth example of the open-ear type sound apparatus of the first embodiment. The open-ear type sound apparatus shown in FIGS. 3 to 6 is a headphone type. FIG. 7 shows a sixth example of the open-ear type sound apparatus of the first embodiment. The open-ear type sound apparatus shown in FIG. 7 is a type that is attached to the frame of glasses. The types shown in FIGS. 1 and 3 to 7 are typical examples of the open-ear type sound apparatus 100, but there is no need to be limited to these. The open-ear type sound apparatus 100 may be an open type, and may have a structure in which there are no parts that come into contact with the concha cavity 910 and the external ear canal 920.

The housing 110 is an open-ear type. The term “open-ear type” means a structure in which the ear hole is kept open to the external environment. The housing 110 also has holding means 191, 192, and 193 for positioning the open-ear type sound apparatus 100 near the ear. In the example of FIG. 1, the holding means 191 holds the device on the ear. In the example of FIGS. 3 to 6, the holding means 192 holds the device on the head. In the example of FIG. 7, the holding means 193 holds the device on the head together with the frame of glasses. The speaker 120 is positioned in the housing 110. In other words, the speaker 120 is positioned in a position that keeps the ear hole open to the external environment. In the example of FIGS. 4 to 6, two speakers 120 are provided. Two or more speakers 120 may be provided.

The protruding portion 130 is held by the housing 110 or formed as a part of the housing 110 so as to be positioned in the hollow space of the concha cavity 910 or the external ear canal 920. In the examples of FIGS. 1, 3, 5, and 7, the protruding portion 130 is rod-shaped. In this case, the protruding portion 130 is held by the housing 110 so as to be positioned in the hollow space of the concha cavity 910 or the external ear canal 920. In the examples of FIGS. 4 and 6, a part of the housing 110 for positioning the speaker 120 also serves as the protruding portion 130. In this way, the protruding portion 130 also includes a shape that is recognized as a part of the housing 110. In other words, the protruding portion 130 may be formed as a part of the housing 110 so as to be positioned in the hollow space of the concha cavity 910 or the external ear canal 920. It is preferable that the position of the protruding portion 130 is adjustable. It is desirable that the protruding portion 130 can be stretched and bent so that its position can be set. It is also desirable that the structure can maintain the set position. If the protruding portion 130 is formed as a part of the housing 110, for example, it is desirable to select a material that can deform for the housing 110 near the protruding portion 130.

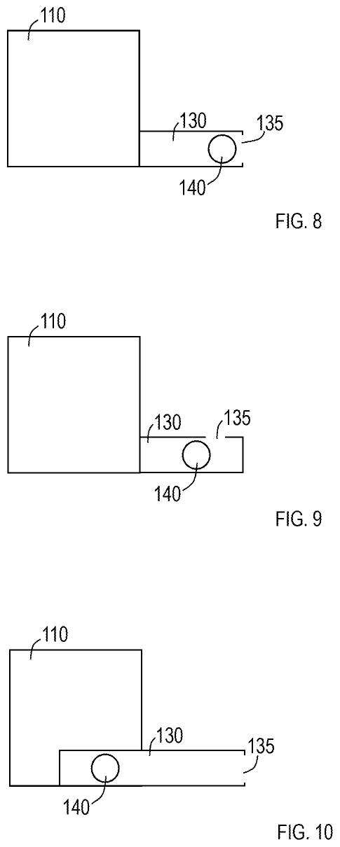

The microphone 140 acquires sound at the position where the protruding portion 130 is positioned. For example, the microphone 140 may be positioned at the tip of the protruding portion 130 as shown in FIGS. 1, 3 to 7. Alternatively, the microphone 140 may be positioned in a space connected to a sound hole 135 formed in the protruding portion 130 as shown in FIGS. 8 to 10. FIG. 8 is a diagram showing an image of a structure in which a sound hole is provided at the tip of the protruding portion and a microphone is positioned inside the protruding portion. FIG. 9 is a diagram showing an image of a structure in which a sound hole is provided midway through the protruding portion and a microphone is positioned inside the protruding portion. FIG. 10 is a diagram showing an image of a structure in which a sound hole is provided at the tip of the protruding portion and a microphone is positioned inside the housing.

The signal processing unit 150 generates a signal to be output from the speaker 120 based on the sound information collected by the microphone 140. For example, when the sound signal to be reproduced by the terminal 200 is reproduced by the speaker 120, the signal processing unit 150 may generate a signal that eliminates external sounds based on the sound information collected by the microphone 140. Alternatively, the signal processing unit 150 may generate a signal that emphasizes external sounds, making the sounds easier to hear, based on the sound information collected by the microphone 140.

The contact determination unit 160 determines whether the protruding portion 130 or the microphone 140 is not in contact with the ear. For example, the contact determination unit 160 may be a contact sensor positioned on the surface of the protruding portion 130 or the microphone 140. Alternatively, the contact determination unit 160 may determine whether there is no contact by analyzing the sound information collected by the microphone 140. This is because, in the case of contact, it is considered that the sound information contains sounds caused by vibrations of the human body, or that the sound information contains sounds of a specific frequency attenuated by the human body. By providing the contact determination unit 160, it is possible to prevent the open-ear type sound apparatus 100 from being used in an unexpected setting.

When the contact determination unit 160 determines that the protruding portion 130 or the microphone 140 is in contact with the ear, the output unit 170 outputs a signal that prompts the user to adjust the position of the protruding portion 130. The signal that prompts the user to make the adjustment may be a signal output from the speaker 120, or may be a signal to be displayed on the terminal 200 if the terminal 200 has a display function. By providing the output unit 170, it becomes easier to inform the user that the protruding portion 130 needs to be adjusted.

The information processing unit 210 is connected to the open-ear type sound apparatus 100, and performs predetermined information processing using the sound information collected by the microphone 140. For example, the information processing unit 210 may process binaural recording, may perform processing associated with measuring the user's headphone transfer function (HpTF), or may perform processing associated with measuring the user's head related transfer function (HRTF). The headphone transfer function (HpTF) refers to the transfer function from the input of the headphones to the ear (the eardrum or the entrance of the external ear canal).

The open-ear type sound apparatus 100 has an open-ear type housing 110 and no parts that come into contact with the concha cavity or external ear canal. Thus, there is little pressure or pain, and risks related to hygiene can be reduced.

### Experiment

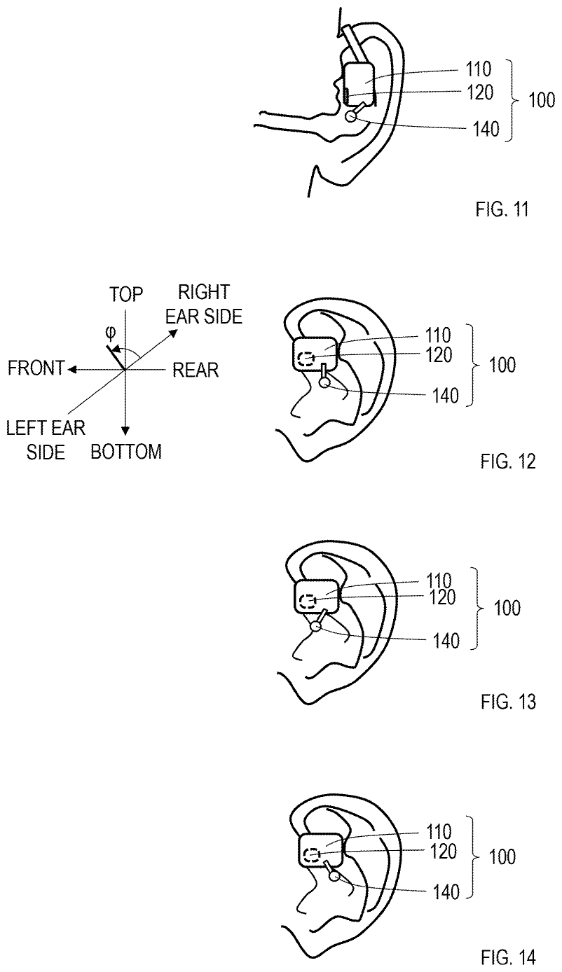

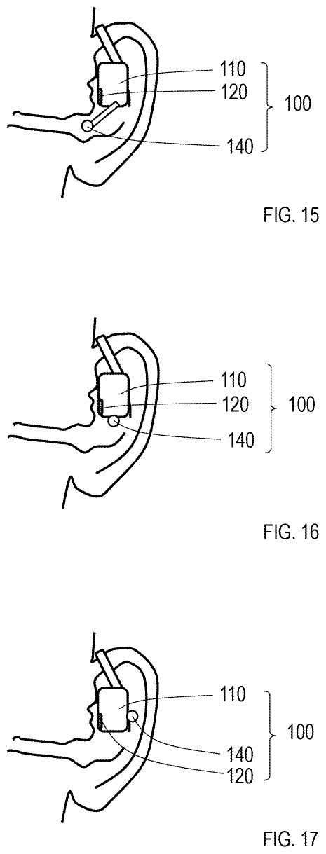

Using the open-ear type sound apparatus 100 of the type shown in FIG. 1 and a dummy head, experiments were conducted on feedback-type active noise cancelling (ANC) processing, headphone transfer function (HpTF) measurement, and head related transfer function (HRTF) measurement. In these experiments, the microphone 140 was positioned in six different positions, as described below. FIG. 11 is a front view of the microphone 140 positioned on the right ear side (φ=0) in the hollow space of the concha cavity of the left ear. FIG. 12 is a left side view of the microphone 140 positioned on the right ear side (φ=0) in the hollow space of the concha cavity of the left ear. FIG. 13 is a left side view of the microphone 140 positioned 30 degrees forward (φ=30) from the right ear side in the hollow space of the concha cavity of the left ear. FIG. 14 is a view from the left side of the microphone 140 positioned 30 degrees behind (φ=−30) from the right ear in the hollow space of the concha cavity of the left ear. The front views for φ=30 and φ=−30 are omitted, but the position of the microphone 140 when viewed from the front is slightly to the right of FIG. 11. The microphone 140 described in FIGS. 11 to 14 is positioned in a plane formed by the axes of the right and left ear sides and the axes of the front and rear sides. In this configuration, the right ear side corresponds to φ=0, the front side is the positive v direction, and the rear side is the negative o direction. FIG. 15 is a front view of the microphone 140 positioned near the external ear hole. FIG. 16 is a front view of the microphone 140 positioned on the side surface of the housing 110 (side surface of the housing). FIG. 17 is a front view of the microphone 140 positioned on the rear surface of housing 110 (the rear surface of the housing). The configuration where the microphone 140 is positioned in the hollow space of the left ear's concha cavity consists of three types: φ=0, φ=30, and φ=−30 (see FIGS. 11 to 14). Additionally, the microphone was positioned in three configurations: near the external ear hole, on the side surface of the housing, and on the rear surface of the housing (see FIGS. 15 to 17). In total, six different configurations were tested in the experiments.

As the primary sound source, airplane cabin noise was reproduced through a speaker positioned 0.8 m in front of the dummy head. The secondary sound source was the speaker 120 of the open-ear type sound apparatus 100 shown in FIGS. 11 to 17.

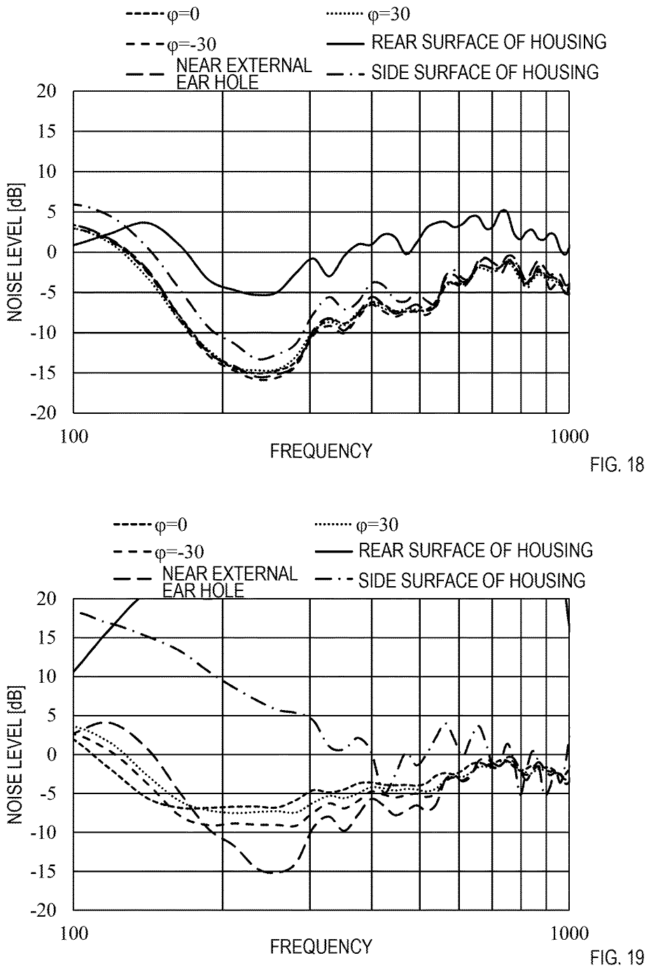

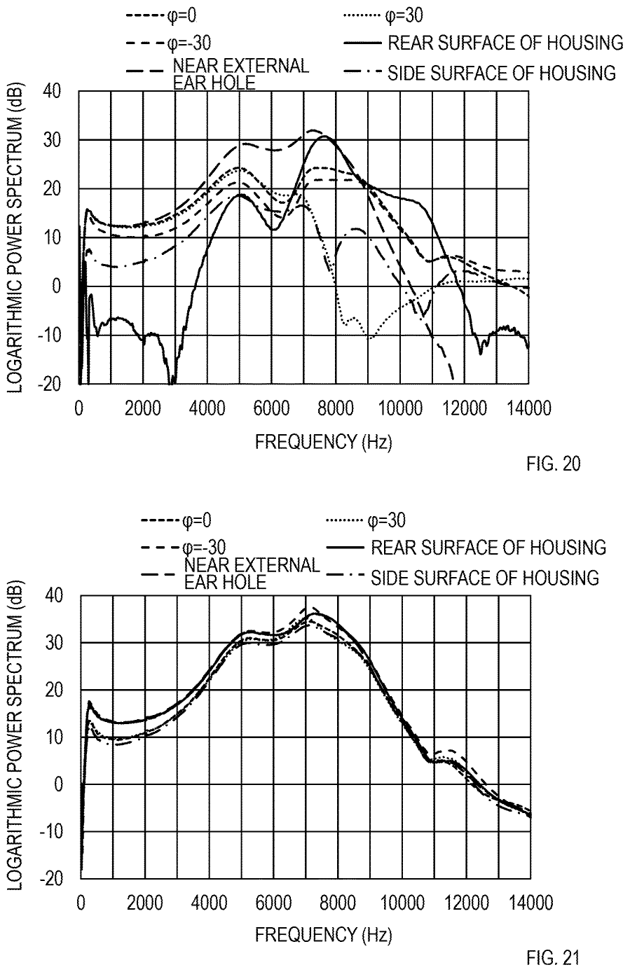

The experimental results of feedback-type active noise cancelling (ANC) processing are shown in FIGS. 18 and 19. Both figures show the noise suppression performance of noise X(f)^{ANC-On} when feedback-type active noise cancelling is applied, relative to noise X(f)^{ANC-Off} when feedback-type active noise cancelling is not applied, for noise reproduced from a primary sound source. FIG. 18 shows the noise suppression performance of noise collected by the microphone 140 when feedback-type active noise cancelling (ANC) is applied using sound information collected by the microphone 140. FIG. 19 shows the noise suppression performance of noise collected by a dummy head in-ear microphone when feedback-type active noise cancelling (ANC) is applied using sound information collected by the microphone 140. The horizontal axis is frequency, and the vertical axis is noise level. FIG. 18 shows that noise can be suppressed at the position of the microphone 140 when positioned other than on the rear surface of the housing. From FIG. 19, it can be seen that when the microphone 140 is positioned near the external ear hole, the noise suppression characteristics are particularly effective in the 200 to 400 Hz range, and overall, noise is effectively suppressed. It can also be seen that when the microphone 140 is positioned in the hollow space of the concha cavity, noise is suppressed by 10 dB or more in the 200 to 600 Hz range in all cases of φ=0, φ=30, and φ=−30. It can also be seen that sufficient noise suppression characteristics cannot be obtained even if the microphone 140 is positioned on the side surface or rear surface of the housing.

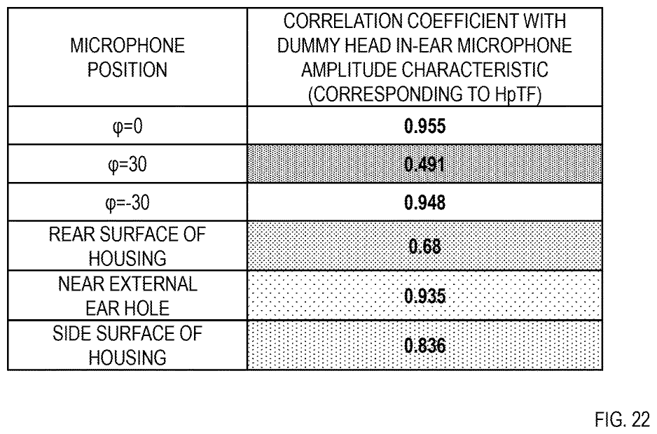

FIGS. 20 to 22 show the experimental results of measuring the headphone transfer function (HpTF). This experiment is an experiment on the transfer function from the secondary sound source (speaker 120) to the dummy head in-ear microphone. FIG. 20 shows the sound collected by the microphone 140 when a TSP (Time Stretched Pulse) signal is reproduced by the secondary sound source. FIG. 21 shows the sound collected by the dummy head in-ear microphone when a TSP signal is reproduced by the secondary sound source. The horizontal axis is frequency, and the vertical axis is logarithmic power spectrum. The experimental results shown in FIG. 21 show subtle differences even though the same sound was reproduced by a secondary sound source and collected by the same dummy head in-ear microphone. This is thought to be due to differences in the mounting position of the open-ear type sound apparatus 100 depending on the type of the microphone 140 position, and differences in the position of the microphone 140. FIG. 22 shows the correlation coefficient between the sound collected by the microphone 140 (sound shown in FIG. 20) and the sound collected by the dummy head in-ear microphone (sound shown in FIG. 21). The correlation coefficient was calculated from the spectrum in the 0 to 14000 Hz range. When the microphone 140 is positioned in the hollow space of the concha cavity, it can be seen that there is a high correlation at φ=0 and φ=−30. On the other hand, the correlation coefficient is small at φ=30. When the microphone 140 is positioned near the external ear hole, it can be seen that there is a sufficiently high correlation. From these results, it can be seen that if the microphone 140 is positioned near the external ear hole, or if a position is appropriately selected to position the microphone 140 in the hollow space of the concha cavity, it may be possible to measure the headphone transfer function (HpTF) of the user using the microphone 140 of the open-ear type sound apparatus 100. In other words, if the protruding portion 130 is held in the housing 110 so as to be positioned in a predetermined hollow space of the concha cavity or in the hollow space of the external ear canal, the information processing unit 210 can perform processing for measuring the headphone transfer function of the user.

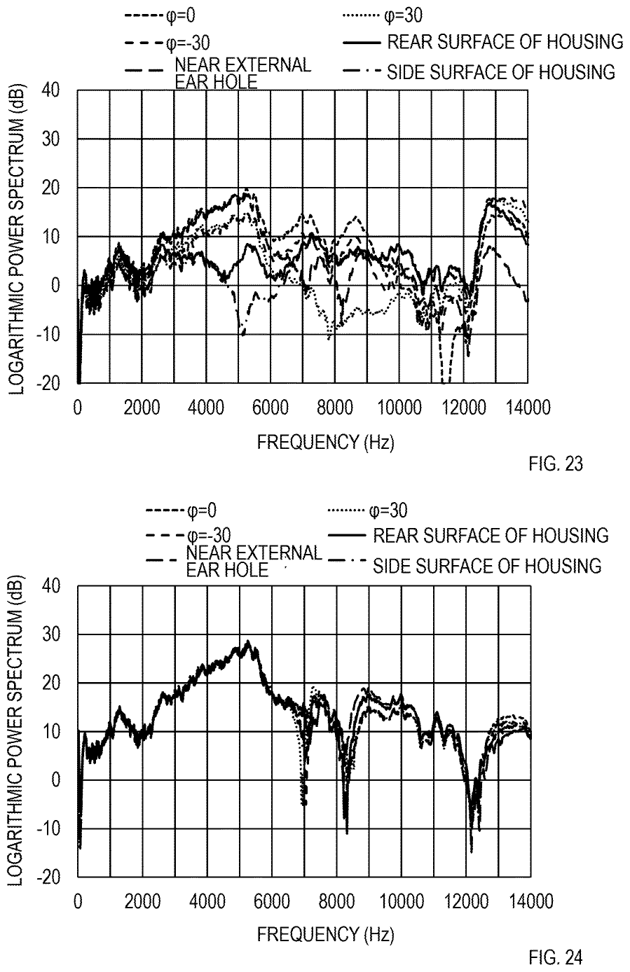

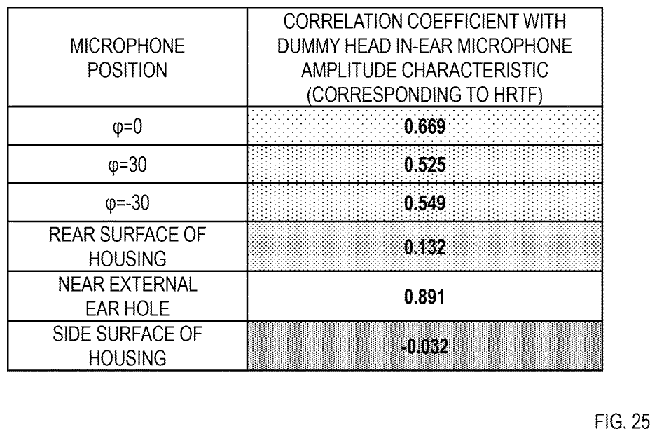

FIGS. 23 to 25 show experimental results of head related transfer function (HRTF) measurement. This experiment is an experiment on the transfer function from the primary sound source (a speaker positioned 0.8 m in front of the dummy head) to the dummy head in-ear microphone. FIG. 23 shows a diagram of the sound reproduced by the primary sound source and collected by the microphone 140. FIG. 24 shows a diagram of the sound reproduced by the primary sound source and collected by the dummy head in-ear microphone. The horizontal axis is frequency, and the vertical axis is logarithmic power spectrum. The experimental results shown in FIG. 24 show subtle differences even though the same sound is reproduced by the primary sound source and collected by the same dummy head in-ear microphone. This is thought to be due to differences in the mounting position of the open-ear type sound apparatus 100 depending on the type of the microphone 140 position, and differences in the position of the microphone 140. FIG. 25 is a diagram showing the correlation coefficient between the sound collected by the microphone 140 (sound shown in FIG. 23) and the sound collected by the dummy head in-ear microphone (sound shown in FIG. 24). The correlation coefficient was calculated from the spectrum in the 0 to 14000 Hz range. It can be seen that there is a sufficiently high correlation when the microphone 140 is positioned near the external ear hole. From this result, it can be seen that if the microphone 140 is positioned near the external ear hole, it is possible to measure the user's head related transfer function (HRTF) using the microphone 140 of the open-ear type sound apparatus 100. It can also be said that it is possible to record (Binaural recording) a sound source to which the user's head related transfer function (HRTF) is applied. In other words, if the protruding portion 130 is held by the housing 110 so as to be positioned in the hollow space of the external ear canal, the information processing unit 210 can perform processing for measuring the user's head related transfer function. The information processing unit 210 can also record a sound source to which the measured head related transfer function is applied.

### Modification 1

The open-ear type sound apparatus 100 of the first embodiment also includes a speaker 120 and a signal processing unit 150. However, if the information processing unit 210 is used to measure the user's head related transfer function (HRTF), the speaker 120 and the signal processing unit 150 are not necessary. The open-ear type sound apparatus of the first modification therefore includes a housing 110, a protruding portion 130, and a microphone 140. The open-ear type sound apparatus 100 of the first modification may be connected to a terminal 200 that includes an information processing unit 210. The housing 110, the protruding portion 130, and the microphone 140 are the same as those of the first embodiment.

The housing of the open-ear type sound apparatus of the modification is also open-ear type, and there are no parts that come into contact with the concha cavity or external ear canal, so there is little pressure or pain, and risks related to hygiene can be reduced.

### REFERENCE SIGNS LIST

10 Sound system
100 Open-ear type sound apparatus
110 Housing
120 Speaker
130 Protruding portion
135 Sound hole
140 Microphone
150 Signal processing unit
160 Contact determination unit
170 Output unit
191, 192, 193 Holding means
200 Terminal
210 Information processing unit

1. An open-ear type sound apparatus comprising:
an open-ear type housing;
a speaker positioned in the housing;
a protruding portion held in the housing or formed as a part of the housing so as to be positioned in a hollow space of a concha cavity or an external ear canal;
a microphone that acquires sound at a position where the protruding portion is positioned; and
a signal processing circuitry that generates a signal to be output from the speaker based on sound information collected by the microphone.

2. The open-ear type sound apparatus according to claim 1, wherein the position of the protruding portion is adjustable.

3. The open-ear type sound apparatus according to claim 2, further comprising:
a contact determination circuitry that determines whether the protruding portion or the microphone is not in contact with the ear.

4. The open-ear type sound apparatus according to claim 3, further comprising:
an output circuitry that outputs a signal that prompts a user to adjust the position of the protruding portion when the contact determination circuitry determines that the protruding portion or the microphone is in contact with the ear.

5. An open-ear type sound apparatus comprising:
an open-ear type housing;
a protruding portion held in the housing or formed as a part of the housing so as to be positioned in a hollow space of a concha cavity or an external ear canal; and
a microphone that acquires sound at a position where the protruding portion is positioned.

6. A sound system comprising:
the open-ear type sound apparatus according to claim 1; and
a terminal connected to the open-ear type sound apparatus and equipped with an information processing circuitry that performs predetermined information processing using sound information collected by the microphone, wherein
the protruding portion is held in the housing or formed as a part of the housing so as to be positioned in a predetermined hollow space of a concha cavity or a hollow space of an external ear canal, and
the information processing circuitry performs processing for measuring a headphone transfer function of a user.

7. A sound system comprising:
the open-ear type sound apparatus according to claim 1; and
a terminal connected to the open-ear type sound apparatus and equipped with an information processing circuitry that performs predetermined information processing using sound information collected by the microphone, wherein
the protruding portion is held by the housing or formed as a part of the housing so as to be positioned in a hollow space of an external ear canal,
the information processing circuitry performs processing for measuring a head related transfer function of a user or processing for recording a sound source to which the head related transfer function is applied.

8. The sound system according to claim 6, wherein
the position of the protruding portion is adjustable.

9. The sound system according to claim 8, wherein
the open-ear type sound apparatus further comprising:
a contact determination circuitry that determines whether the protruding portion or the microphone is not in contact with the ear.

10. The sound system according to claim 9, wherein
the open-ear type sound apparatus further comprising:
an output circuitry that outputs a signal that prompts a user to adjust the position of the protruding portion when the contact determination circuitry determines that the protruding portion or the microphone is in contact with the ear.

11. The sound system according to claim 7, wherein
the position of the protruding portion is adjustable.

12. The sound system according to claim 11, wherein
the open-ear type sound apparatus further comprising:
a contact determination circuitry that determines whether the protruding portion or the microphone is not in contact with the ear.

13. The sound system according to claim 12, wherein
the open-ear type sound apparatus further comprising:
an output circuitry that outputs a signal that prompts a user to adjust the position of the protruding portion when the contact determination circuitry determines that the protruding portion or the microphone is in contact with the ear.

14. A sound system comprising:
the open-ear type sound apparatus according to claim 5; and
a terminal connected to the open-ear type sound apparatus and equipped with an information processing circuitry that performs predetermined information processing using sound information collected by the microphone, wherein
the protruding portion is held by the housing or formed as a part of the housing so as to be positioned in a hollow space of an external ear canal,
the information processing circuitry performs processing for measuring a head related transfer function of a user or processing for recording a sound source to which the head related transfer function is applied.

15. The open-ear type sound apparatus according to claim 1, wherein the housing does not come into contact with the concha cavity and the external ear canal.

16. The open-ear type sound apparatus according to claim 15, wherein the position of the protruding portion is adjustable so that the protruding portion and a microphone do not come into contact with the concha cavity and the external ear canal.

17. The open-ear type sound apparatus according to claim 16, further comprising:
a contact determination circuitry that determines whether the protruding portion or the microphone is not in contact with the ear.

18. The open-ear type sound apparatus according to claim 17, further comprising:
an output circuitry that outputs a signal that prompts a user to adjust the position of the protruding portion when the contact determination circuitry determines that the protruding portion or the microphone is in contact with the ear.

19. The open-ear type sound apparatus according to claim 5, wherein the housing does not come into contact with the concha cavity and the external ear canal.

20. The open-ear type sound apparatus according to claim 19, wherein
the position of the protruding portion is adjustable so that the protruding portion and a microphone do not come into contact with the concha cavity and the external ear canal.
